(19) United States
(12) Patent Application Publication
(10) Pub. No.: US 2016/0224453 A1
(43) Pub. Date: Aug. 4, 2016

(54) MONITORING THE QUALITY OF SOFTWARE SYSTEMS

(71) Applicant: Lindedln Corporation, Mountain View, CA (US)

(72) Inventors: Yi Wang, Sunnyvale, CA (US); Sheng Zhao, Sunnyvale, CA (US); Xian Li, San Jose, CA (US); Keith Wai Kit Tsang, Fremont, CA (US); Aarti Kumar, San Carlos, CA (US); Alex Ching Lai, Menlo Park, CA (US)

(21) Appl. No.: 14/631,743

(22) Filed: Feb. 25, 2015

Related U.S. Application Data
(60) Provisional application No. 62/110,231, filed on Jan. 30, 2015.

(51) Int. Cl. G06F 11/36; G06F 9/44

(52) U.S. Cl. CPC G06F 11/3604; G06F 8/71

(57) ABSTRACT

A machine may be configured to monitor the quality of software systems based on key performance indicators associated with versions of various units of code. For example, the machine accesses a current version of a unit of code that is not marked as evaluated, in a database. The machine generates a current key performance indicator (KPI) value for the current version of the unit of code based on an execution of the current version of the unit of code. The machine identifies a previous KPI value associated with a previous version of the unit of code that is marked as evaluated, in the database. The machine determines that the current KPI value is less than the previous KPI value and generates an alert for presentation in a user interface of a device. The alert may indicate a decreasing quality level associated with the current version of the unit of code.

### CLAIM OF PRIORITY

This application claims the benefit of priority, under 35 U.S.C. Section 119(e), U.S. Provisional Patent Application No. 62/110,231 (Attorney Docket No. 3080.C94PRV) by Wang et al., filed on Jan. 30, 2015, which is hereby incorporated herein by reference in its entirety.

### TECHNICAL FIELD

The present application relates generally to the processing of data, and, in various example embodiments, to systems, methods, and computer program products for monitoring the quality of software systems based on generating key performance indicators for various units of code and evaluating the generated key performance indicators against previous key performance indicators associated with previous versions of the various units of code.

### BACKGROUND

Some engineering teams utilize the practices of “continuous integration” and “unit testing” for their software development work. Continuous integration is the practice, in software engineering, of merging all developer working copies with a shared mainline several times a day. In computer programming, unit testing is a software testing method by which individual units of source code, sets of one or more computer program modules together with associated control data, usage procedures, and operating procedures, are tested to determine whether they are fit for use.

Continuous integration was originally intended to be used in combination with automated unit tests written through the practices of test-driven development. Initially, continuous integration included running all unit tests in the developer's local environment and verifying that they all passed before committing the software to a mainline. This helped avoid one developer's work in progress breaking another developer's copy. Later elaborations of the concept introduced build servers, which automatically run the unit tests periodically or even after every commit and report the results to the developers.

A unit may be the smallest testable part of an application. In procedural programming, a unit could be an entire module, but it is more commonly an individual function or procedure. In object-oriented programming, a unit is often an entire interface, such as a class, but could be an individual method. Unit tests may be short code fragments created by programmers during the development process. The unit tests may call various modules (or units) of the monitored systems using pre-designed inputs and determine whether the outputs are equal to expected output values. If they are not equal, it may be inferred that some recent changes to the modules have caused them to not function as expected.

In addition to automated unit tests, organizations using continuous integration typically use a build server to implement continuous processes of applying quality control in general—small pieces of effort, applied frequently. This continuous application of quality control aims to improve the quality of software, and to reduce the time taken to deliver it, by replacing the traditional practice of applying quality control after completing all development.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a quality monitoring system, according to some example embodiments;

FIG. 3 is diagram illustrating a plurality of graphs representing KPIs associated with a unit of code, according to some example embodiments;

FIG. 4 is a diagram illustrating a directed graph representing version descriptions of a plurality of versions of a unit of code and the KPIs associated with the respective versions of the unit of code, according to some example embodiments;

FIG. 5 is a flowchart illustrating a method of monitoring the quality of software, according to some example embodiments;

FIG. 6 is a flowchart illustrating a method of monitoring the quality of software, and representing additional steps of the method illustrated in FIG. 5, according to some example embodiments;

FIG. 7 is a flowchart illustrating a method of monitoring the quality of software, and representing additional steps of the method illustrated in FIG. 5, according to some example embodiments;

FIG. 8 is a flowchart illustrating a method of monitoring the quality of software, and representing additional steps of the method illustrated in FIG. 5, according to some example embodiments;

FIG. 9 is a flowchart illustrating a method of monitoring the quality of software, and representing step 502 of the method illustrated in FIG. 5 in more detail and additional steps of the method illustrated in FIG. 5, according to some example embodiments;

FIG. 10 is a flowchart illustrating a method of monitoring the quality of software, and representing step 504 of the method illustrated in FIG. 8, according to some example embodiments; and

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems for monitoring the quality of software systems based on generating key performance indicators for various units of code and evaluating the generated key performance indicators against previous key performance indicators associated with previous versions of the various units of code are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In recent decades, machine intelligent systems (e.g., data mining systems, machine learning systems, search engines, recommendation systems, or online advertising systems) are enhancing Internet-based industries by enabling better and smarter Internet services. Continuous integration is a software engineering mechanism that facilitates the monitoring of the quality of software systems with deterministic behavior. The machine intelligent systems, however, often utilize stochastic algorithms to solve prediction problems that may have nondeterministic outputs. The stochastic algorithms cannot be tested thoroughly by comparing actual outputs with expected outputs that are fixed or deterministic.

A continuous evaluation system which runs “unit evaluation” programs instead of “unit test” programs may be more suitable for monitoring the quality of software systems with nondeterministic (e.g., stochastic) outputs. As stated above, unit tests utilized in the continuous integration practice are designed to compare the output of a unit of code and an expected output. A unit evaluation program utilized by a continuous evaluation system, unlike a unit test, may generate one or more key performance indicators (KPIs) for a version of a unit of code based on an analysis of the output associated with the version of the unit of code. The KPI may be a numerical value between 0 and 1 that conveys the quality level of a particular performance attribute associated with the output. In some example embodiments, the KPIs are statistic metrics, such as precision, recall, or F-measure.

For example, in a pattern recognition or information retrieval context, a precision KPI indicates the fraction of retrieved instances that are relevant. A recall KPI in the pattern recognition or information retrieval context indicates the fraction of relevant instances that are retrieved. According to another example, in a classification context, the precision KPI measures the number of true positives (e.g., the number of items correctly labeled as belonging to the positive class) divided by the total number of elements labeled as belonging to the positive class (e.g., the sum of true positives and false positives, which are items incorrectly labeled as belonging to the class). The recall KPI in the classification context indicates the number of true positives divided by the total number of elements that actually belong to the positive class (e.g., the sum of true positives and false negatives, which are items which were not labeled as belonging to the positive class but should have been).

The continuous evaluation system may evaluate (e.g., compute one or more KPI values for) one or more commits (e.g., versions of units of code) of the software system being monitored. The continuous evaluation system may then compare the KPI value of a particular type, associated with a recent version of a particular unit of code, and the KPI value of the same type, associated with a previous version of the particular unit of code. The continuous evaluation system may issue an alert if a KPI value associated with a recent commit is lower than the KPI value from an older commit. By generating statistical metrics of the quality of the output of a unit of code and comparing later statistical metrics for the unit of code to previous statistical metrics for the unit of code, the continuous evaluation system may determine whether the quality of the unit of code is improving.

For example, the continuous evaluation system determines whether two records refer to the same company (or have other similarities, such as being duplicates of the same record). The two records may be in different languages (e.g., English and Chinese) while referring to the same company. This may be a prediction problem. Given the two records, the continuous evaluation system predicts the value of a binary variable E, which is true when the two records refer to the same company or false when the two records do not refer to the same company. To perform the prediction process, the continuous evaluation system may utilize a random forest tree model. In some instances, the prediction process includes changing the source code to evolve the model and to incorporate new features. Because the changes to the source code may improve or decreases the accuracy of the prediction results, the continuous evaluation system evaluates every change of the source code to check the accuracy. To do so, in some instances, the continuous evaluation system accesses test data of record pairs previously labeled (e.g., by a human editor) to indicate whether each pair refers to the same company. A unit evaluation program may call the random forest model to generate a predicted label for each record pair, and compare the predicted label with the previously assigned label (e.g., by the human editor). The comparison result can be represented by a Kendall’ tau coefficient, which is a statistics of the number of concordant pairs and the number of discordant pairs. The greater the number of concordant pairs and the smaller the number of discordant pairs, the greater the Kendall's tau coefficient. In some instances, the Kendall's tau is one of the KPIs computed by the continuous evaluation system.

In some example embodiments, the continuous evaluation system evaluates the LinkedIn™ (also “LinkedIn”) People You May Know (PYMK) feature. PYMK is a recommender system. For every LinkedIn particular member, the PYMK system finds a list of other members who might have career overlaps with the particular member. Developers may be interested in the quality of performance of the data mining method behind the PYMK system: whether the PYMK system can identify known people accurately. Generally, a recommender system generates a list of candidates in the descending order of “likely known” by a particular member. A LinkedIn web page may show identifiers of a number of candidates in the top of the generated list of candidates. The more candidates are shown, the higher the likelihood that more known candidates are shown. This is known as recall. If the web page has limited space to show only top few candidates, in some instances, it may be desirable to display only identifiers of known candidates. This is known as precision. Recall and precision are two KPIs that may be utilized for the evaluation of the PYMK system. The continuous evaluation system, in some instances, utilizes human-labelled test data and a unit evaluation program that calls the recommender system with test data and outputs the precision and recall KPIs.

In some example embodiments, the continuous evaluation system accesses test data, calls a unit of code (also “module”) being evaluated, inputs the test data to the unit of code being evaluated, analyzes the output generated based on executing the unit of code, computes a current KPI value of a particular type based on the output, and stores the current KPI value in a record of a database, in association with a reference to the unit of code. The continuous evaluation system accesses a preceding KPI value associated with a reference to the unit of code in a database, determines that the preceding KPI value is of the same particular type as the current KPI value, and compares the current KPI value with the preceding KPI value. If the continuous evaluation system determines that the current KPI value is lower than the preceding KPI value, the continuous evaluation system may generate and transmit a communication to an engineer indicating that the current KPI value for the unit of code is below a preceding KPI value for the unit of code. A lower KPI value may indicate that there is something wrong with the unit of code, such as a bug introduced by one or more changes to an older version of the unit of code. The analysis, by the continuous evaluation system, of the KPI values associated with various versions of a unit of code facilitates the automatic identification of code changes that negatively impact the output. In some instances, the continuous evaluation system automatically rejects newer versions of the units of code that are associated with KPI values lower than the corresponding KPI values associated with previous versions of the units of code.

In some example embodiments, the continuous evaluation system, like a continuous integration system, automatically builds the software modules and unit tests. In addition, the continuous evaluation system builds the unit evaluations programs. The functionality of a unit evaluation program may include calling the unit of code to be evaluated, passing input data to the unit of code, and checking the output data by generating a summarization (e.g., computing one or more KPIs) for the unit of code.

Moreover, the continuous evaluation system may build one or more versions of a software. Systems like GIT or SVN may facilitate the automatic organization of the software development work progress with a directed graph of minor versions of the software. The continuous evaluation system may build one or more versions in this graph. For each version, the continuous evaluation system runs one or more unit evaluation programs that generate the KPI values for the version (e.g., for the units of code in the version). For example, a unit evaluation program calls a program to be evaluated, and collects output from the program to be evaluated. The unit evaluation program then computes one or more KPIs that measure how well the program to be evaluated worked based on the collected output. The unit evaluation program might call one or more programs to be evaluated. For each program, the unit evaluation program computes one or more KPIs. In some instances, the unit evaluation program reports each KPI to the unit evaluation system as a tuple of <code-commit-id, data-commit-id, KPI-value>.

The functionalities of the continuous evaluation system may be performed by a single computer or may be distributed across multiple computers. The unit evaluation programs may be located on the same computer as the rest of the continuous evaluation system, or may be located on remote machines (e.g., on a developer's local machine). The unit evaluation programs may report (or communicate) the computed KPIs to a module of the continuous evaluation system for further analysis (e.g., for comparison with preceding KPIs).

In some example embodiments, the continuous evaluation system generates a graphical representation of the KPIs associated with a plurality of versions of a unit of code and causes the presentation of the graphical representation of the KPIs in a user interface of a device of a user (e.g., an engineer). For example, the display of a graph that illustrates the KPI values associated with a series of versions of a unit of code facilitates the visualization of the evolvement of the quality of the unit of code and the identification of any versions that include code changes that negatively impact the output of the software.

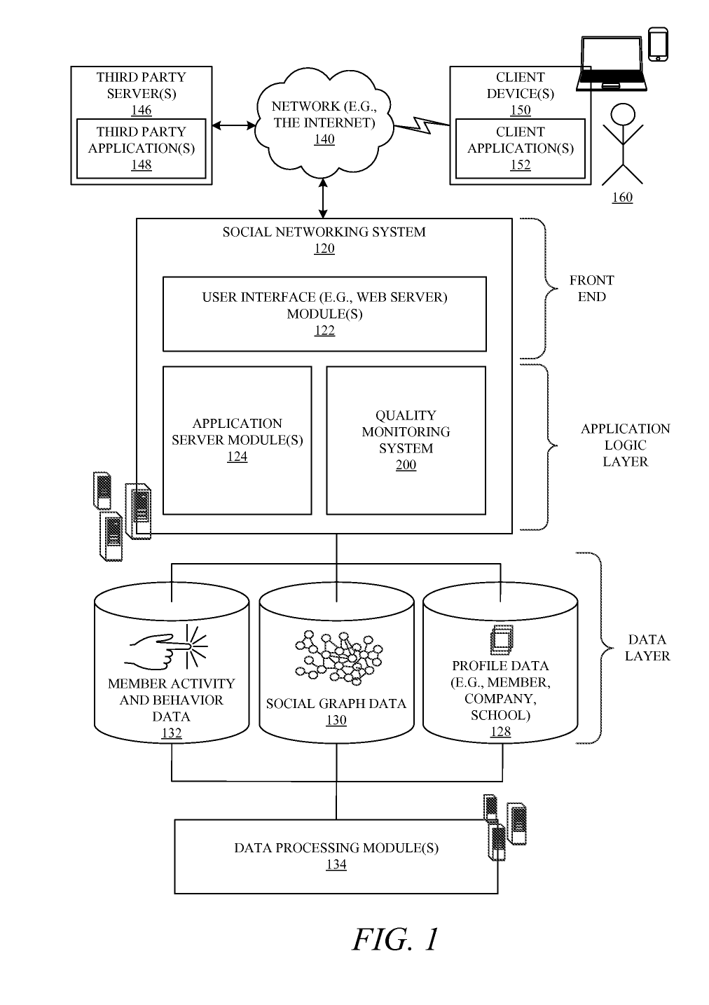

An example method and system for monitoring the quality of software systems based on generating key performance indicators for various units of code and evaluating the generated key performance indicators against previous key performance indicators associated with previous versions of the various units of code, may be implemented in the context of the client-server system illustrated in FIG. 1. As illustrated in FIG. 1, the quality monitoring system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the quality monitoring system 200, which is described in more detail below.

Further, as shown in FIG. 1, a data processing module 134 may be used with a variety of applications, services, and features of the social networking system 120. The data processing module 134 may periodically access one or more of the databases 128, 130, 132, or a test data repository, process (e.g., execute batch process jobs to analyze or mine) profile data, social graph data, member activity and behavior data, or test data for unit evaluations, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

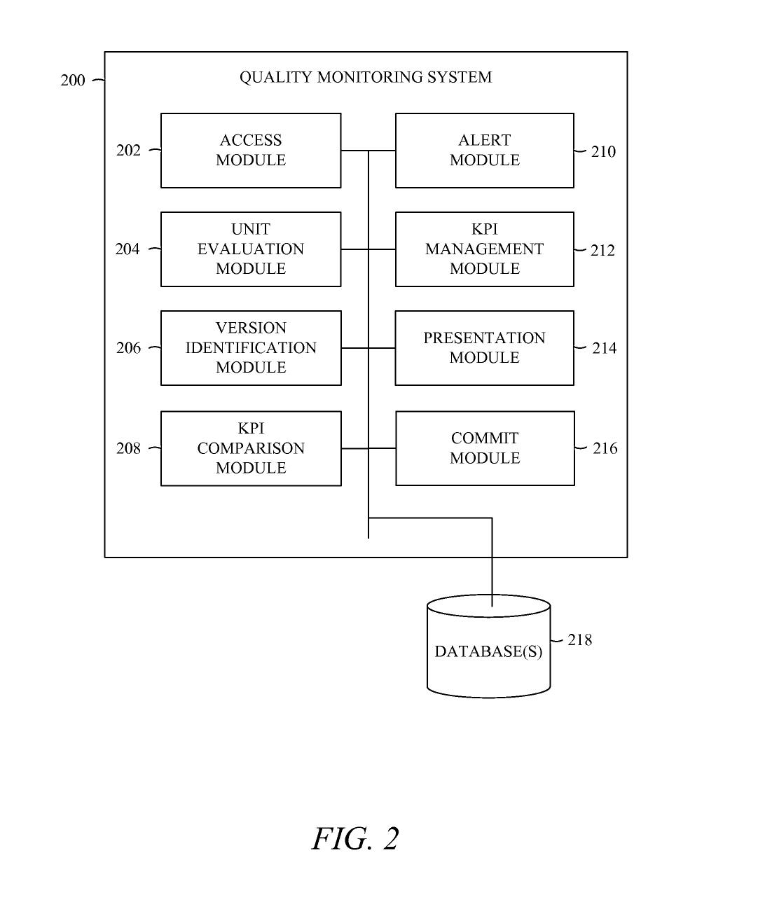

FIG. 2 is a block diagram illustrating components of the quality monitoring system 200, according to some example embodiments. As shown in FIG. 2, the quality monitoring system 200 includes an access module 202, a unit evaluation module 204, a version identification module 206, a KPI comparison module 208, an alert module 210, a KPI management module 212, a presentation module 214, and a commit module 216, all configured to communicate with each other (e.g., via a bus, shared memory, or a switch).

According to some example embodiments, the access module 202 accesses (e.g., receives) a current version of a unit of code that is not marked as evaluated, in a database. The unit evaluation module 204 generates a current key performance indicator (KPI) value for the current version of the unit of code. The generating of the current KPI value may be based on an execution of the current version of the unit of code. The generating of the current KPI is performed by one or more hardware processors.

The version identification module 206 identifies a previous KPI value associated with a previous version of the unit of code that is marked as evaluated, in the database. The previous version of the unit of code may be the version of the unit of code that immediately precedes the current version of the unit of code. The identifying of the previous KPI value may include accessing a record in a database, that associates the previous version of the unit of code and a previous KPI value generated based on the previous version of the unit of code, and determining that the previous version of the unit of code is marked as evaluated (e.g., previously evaluated by the unit evaluation module 204). In some example embodiments, a previously evaluated version of the unit of code is associated with one or more KPI values, and is marked (e.g., tagged) as evaluated. An unevaluated version of the unit of the code is not associated with one or more KIP values, and is not marked as evaluated. In some instances, the unevaluated version of the unit of code is marked as unevaluated.

The KPI comparison module 208 determines that the current KPI value is less than the previous KPI value. The determining that the current KPI value is less than the previous KPI value is based on comparing the current KPI value and the previous KPI value.

The alert module 210 generates an alert based on the determining that the current KPI value is less than the previous KPI value. The alert is generated for presentation in a user interface of a device. The device may be associated with a user of the quality monitoring system (e.g., an engineer). The alert may be a communication transmitted to the device, and may indicate a decreasing quality level associated with the current version of the unit of code.

The KPI management module 212 accesses (e.g., receives from the unit evaluation module 204) the current KPI value and stores the current KPI value in a record of a database. The current KPI value may be stored in the record of the database in association with a reference to the current version of the unit of code. The KPI management module 212 may also mark the current version of the unit of code as evaluated, in the database.

The presentation module 214 generates a representation of a plurality of KPI values corresponding to a plurality of versions of the unit of code. The plurality of KPI values may include the current and previous KPI values. The presentation module 214 causes a display of the representation of the plurality of KPI values in a user interface of a device. The presentation module 214 may also generate a representation of a plurality of version descriptions corresponding to a plurality of versions of the unit of code. The presentation module 214 may also cause a display of the representation of the plurality of version descriptions in a user interface of a device.

In some example embodiments, the access module 202 checks out a source code of a system monitored for quality, from a source code repository to a local code repository. The access module 202 also checks out test data used to generate one or more KPIs, including the current KPI, from a data repository to a local data repository.

The commit module 216 identifies one or more commits of versions of the unit of code to the source code repository, that are not marked as evaluated, in the database, the one or more versions of the unit of code including the current version of the unit of code. The commit module 216 also performs a build of the one or more commits.

To perform one or more of its functionalities, the quality monitoring system 200 may communicate with one or more other systems. An integration engine may integrate the quality monitoring system 200 with one or more email server(s), web server(s), a source code repository, a data repository, or other servers or systems. A measurement and reporting engine may determine the performance of one or more modules of the quality monitoring system 200. An optimization engine may optimize one or more of the models associated with one or more modules of the quality monitoring system 200.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 218 (e.g., a test data repository, the database 128, the database 130, the database 132, etc.).

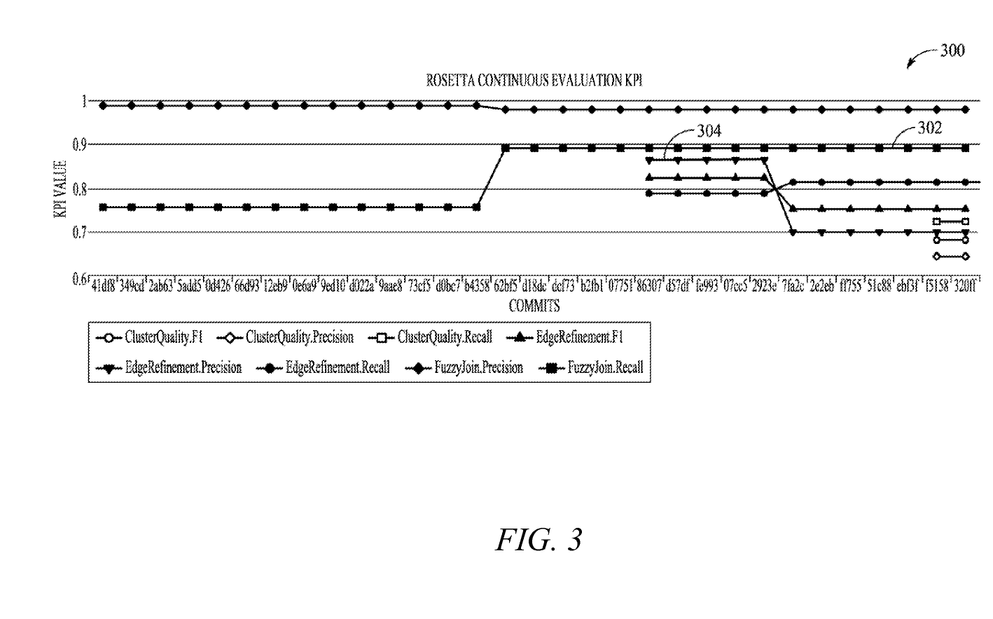

FIG. 3 is diagram 300 illustrating a plurality of graphs representing KPIs associated with a unit of code, according to some example embodiments. As shown in FIG. 3, a unit of code may be associated with a variety of key performance indicators (KPIs), such as ClusterQuality.F1, ClusterQuality.Precision, ClusterQuality.Recall, EdgeRefinement.F1, EdgeRefinement.Precision, EdgeRefinement.Recall, FuzzyJoin.Precision, and FuzzyJoin.Recall. These KPIs may take a particular value for a particular version of the unit of code. The KPIs, shown in FIG. 3, are represented in graph form, where each node of a particular graph corresponds to a particular KPI value between 0 and 1, and where each node corresponds to a particular version (or commit) of the unit of code.

The graphical representation of the KPIs associated with various versions of the unit of code may assist a user to visualize the evolution of the quality of the unit of code from version to version. For example, the graph 302 representing the FuzzyJoin.Recall KPI shows an improvement in quality in version 62bf5 of the unit of code. As shown in FIG. 3, the FuzzyJoin.Recall value associated with version 62bf5 is approximately 0.89, while the FuzzyJoin.Recall value associated with the preceding version b4358 is approximately 0.76. According to another example, the graph 304 representing the EdgeRefinement.Precision KPI shows a drop in quality in version 7fa2c of the unit of code, as compared to the preceding version 2923e. As shown in FIG. 3, the EdgeRefinement.Precision value associated with version 7fa2c is approximately 0.7, while the EdgeRefinement.Precision value associated with version 2923e is approximately 0.87.

In some example embodiments, the quality monitoring system 200 generates a representation of a plurality of KPI values corresponding to a plurality of versions of the unit of code, the plurality of KPI values including the current and previous KPI values, and causes a display of the representation of the plurality of KPI values in a user interface of a device. The representation may comprise a graph including a plurality of nodes, each node representing a KPI value associated with a corresponding version of a plurality of versions of the unit of code.

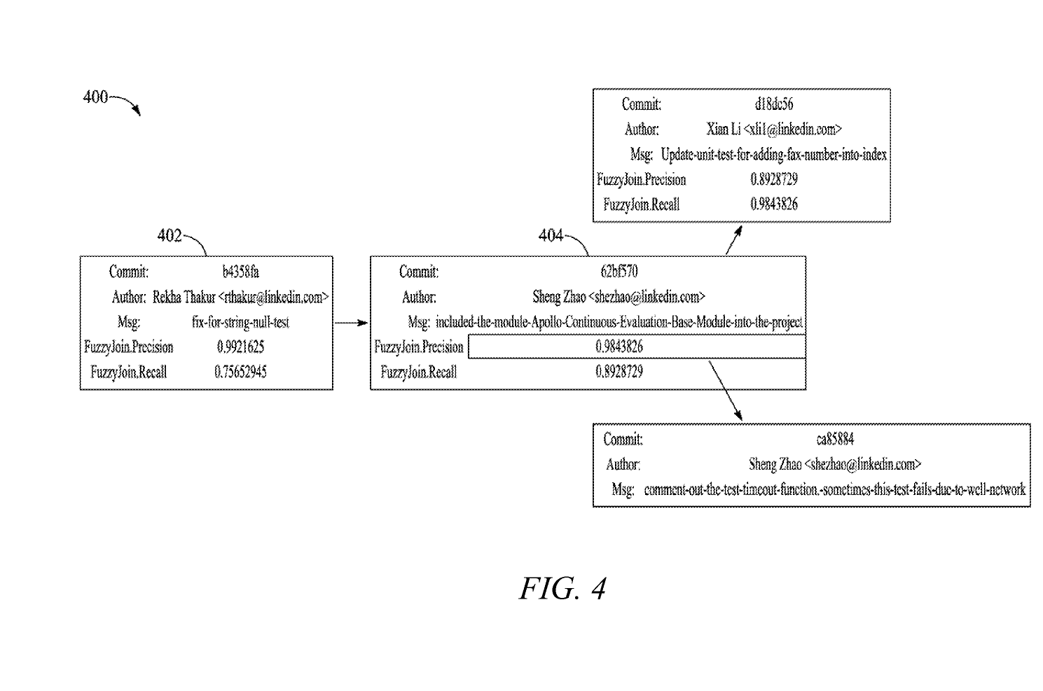

FIG. 4 is a diagram illustrating a directed graph 400 representing version descriptions of a plurality of versions of a unit of code and the KPIs associated with the respective versions of the unit of code, according to some example embodiments. The quality monitoring system 200 generates a representation of a plurality of version descriptions corresponding to a plurality of versions of the unit of code, and causes a display of the representation of the plurality of version descriptions in a user interface of a device. The version descriptions may include a variety of information pertaining to a particular version (or commit) of the unit of code, such as a version identifier (ID) (or commit ID), an author ID (e.g., a name or email address of the author), a message that identifies a change performed to the unit of code in the particular version of the unit of code, and one or more KPIs.

The representation may comprise a graph including a plurality of nodes. One or more nodes of the plurality of nodes may include a version identifier that identifies a particular version of the plurality of versions of the unit of code and one or more KPI values generated based on the particular version of the plurality of versions of the unit of code. For example, as shown in FIG. 4, the node 402 of the graph 400 includes the identifier “b4358fa” of a particular version of the unit of code. The node 402 also includes the FuzzyJoin.Precision KPI with the value of 0.9921625 and the FuzzyJoin.Recall KPI with the value 0.75652945.

The graphical representation of various versions of the unit of code may assist a user of the quality monitoring system 200 to visualize a sequence of versions of the unit of code, review the KPIs associated with the sequence of versions, and determine whether a particular version (e.g., a current version) is of lesser quality than a prior version (e.g., the version immediately preceding the current version) based on a comparison of the KPI values of a particular type in the respective versions.

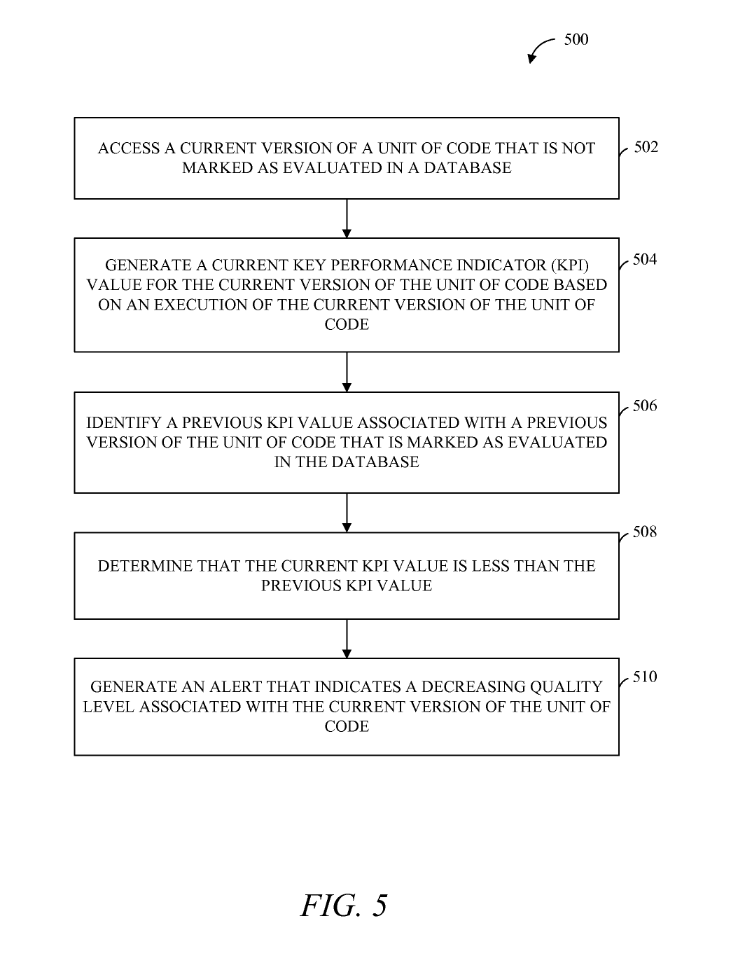

FIGS. 5-10 are flowcharts illustrating a method of monitoring the quality of software systems based on generating key performance indicators for various units of code and evaluating the generated key performance indicators against previous key performance indicators associated with previous versions of the various units of code, according to some example embodiments. Operations in the method 500 illustrated in FIG. 5 may be performed using modules described above with respect to FIG. 2. As shown in FIG. 5, the method 500 may include one or more of method operations 502, 504, 506, 508, and 510, according to some example embodiments.

At method operation 502, the access module 202 accesses a current version of a unit of code that is not marked as evaluated, in a database. In some example embodiments, a particular version of the unit of code has been marked as evaluated after a KPI value was generated for the particular version based on the particular version of the unit of code and associated with the particular version of the unit of code, in a record of a database.

At method operation 504, the unit evaluation module 204 generates a current key performance indicator (KPI) value for the current version of the unit of code. The generating of the current KPI value may be based on an execution of the current version of the unit of code. In some example embodiments, the generating of the KPI value for the current version of the unit of code is based on an output resulting from the execution of the current version of the unit of code. In various example embodiments, upon the unit evaluation module generating the current KPI value for the current version of the unit of code, KPI management module 212 marks the current version of the unit of code as evaluated, in a record of a database.

At method operation 506, the version identification module 206 identifies a previous KPI value associated with a previous version of the unit of code that is marked as evaluated, in the database. In some example embodiments, the identifying of the previous KPI value associated with a previous version of the unit of code includes accessing a record of a database and identifying a particular version of the unit of code that has been committed to a source code repository prior to the current version of the unit of code and that has been marked as evaluated.

The previous version of the unit of code may be the version of the unit of code that immediately precedes the current version of the unit of code. In some example embodiments, an evaluated version of the unit of code is associated with one or more KPI values. An unevaluated version of the unit of the code is not associated with one or more KIP values, and is not marked as evaluated. In some instances, the unevaluated version of the unit of code is marked as unevaluated.

In some example embodiments, the current and previous KPI values are statistics metrics of a particular type. According to one example, the current KPI value identifies a current precision value generated based on the output resulting from the execution of the current version of the unit of code and the previous KPI value identifies a previous precision value generated based on the output resulting from the execution of the previous version of the unit of code. According to another example, the current KPI value identifies a current recall value generated based on the output resulting from the execution of the current version of the unit of code and the previous KPI value identifies a previous recall value generated based on the output resulting from the execution of the previous version of the unit of code. According to yet another example, the current KPI value identifies a current F-measure value generated based on the output resulting from the execution of the current version of the unit of code and the previous KPI value identifies a previous F-measure value generated based on the output resulting from the execution of the previous version of the unit of code.

At method operation 508, the KPI comparison module 208 determines that the current KPI value is less than the previous KPI value. The determining that the current KPI value is less than the previous KPI value is based on comparing the current KPI value and the previous KPI value.

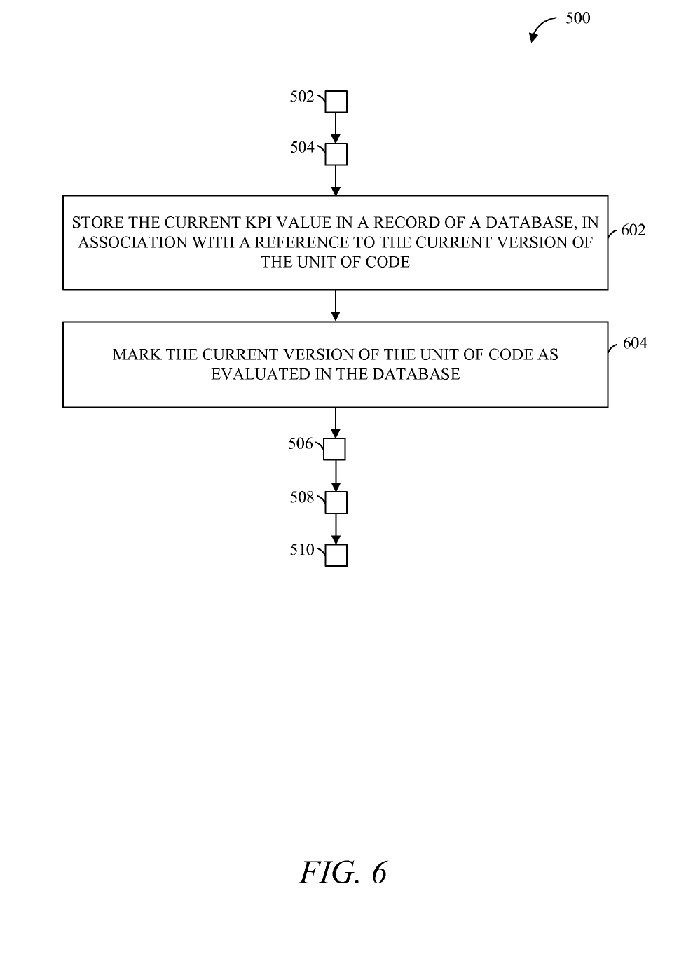

At method operation 510, the alert module 210 generates an alert based on the determining that the current KPI value is less than the previous KPI value. The alert may be generated for presentation in a user interface of a device. The device may be associated with a user of the quality monitoring system (e.g., an engineer). In some example embodiments, the alert includes a communication transmitted to the device. The communication may indicate a decreasing quality level associated with the current version of the unit of code. Further details with respect to the method operations of the method 500 are described below with respect to FIGS. 6-10.

As shown in FIG. 6, the method 500 may include one or more of method operations 602 and 604, according to some example embodiments. Method operation 602 is performed after method operation 504, in which the unit evaluation module 204 generates a current KPI value for the current version of the unit of code.

At method operation 602, the KPI management module 212 stores the current KPI value in a record of a database. The current KPI may be stored in association with a reference to the current version of the unit of code. In some example embodiments, the KPI management module 212 receives from the unit evaluation module 204 the current KPI value before storing the current KPI value in the record of the database.

Method operation 604 is performed after method operation 602. At method operation 604, the KPI management module 212 marks (e.g., identifies) the current version of the unit of code as evaluated, in the database.

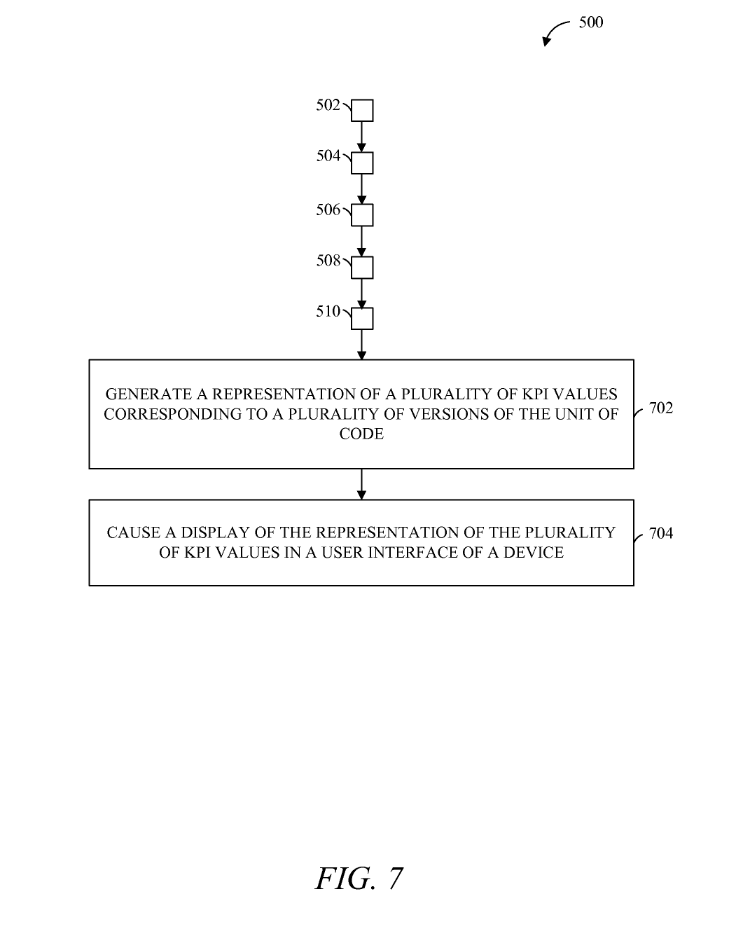

As shown in FIG. 7, the method 500 may include one or more of method operations 702 and 704, according to some example embodiments. Method operation 702 is performed after method operation 510, in which the alert module 210 generates an alert based on the determining that the current KPI value is less than the previous KPI value.

At method operation 702, the presentation module 214 generates a representation of a plurality of KPI values corresponding to a plurality of versions of the unit of code. The plurality of KPI values may include the current and previous KPI values.

Method operation 704 is performed after method operation 702. At method operation 704, the presentation module 214 causes a display of the representation of the plurality of KPI values in a user interface of a device. In some example embodiments, the representation comprises a graph including a plurality of nodes. Each node of the plurality of nodes represents a KPI value associated with a corresponding version of a plurality of versions of the unit of code. The corresponding version is the version based on which the respective KPI value was generated.

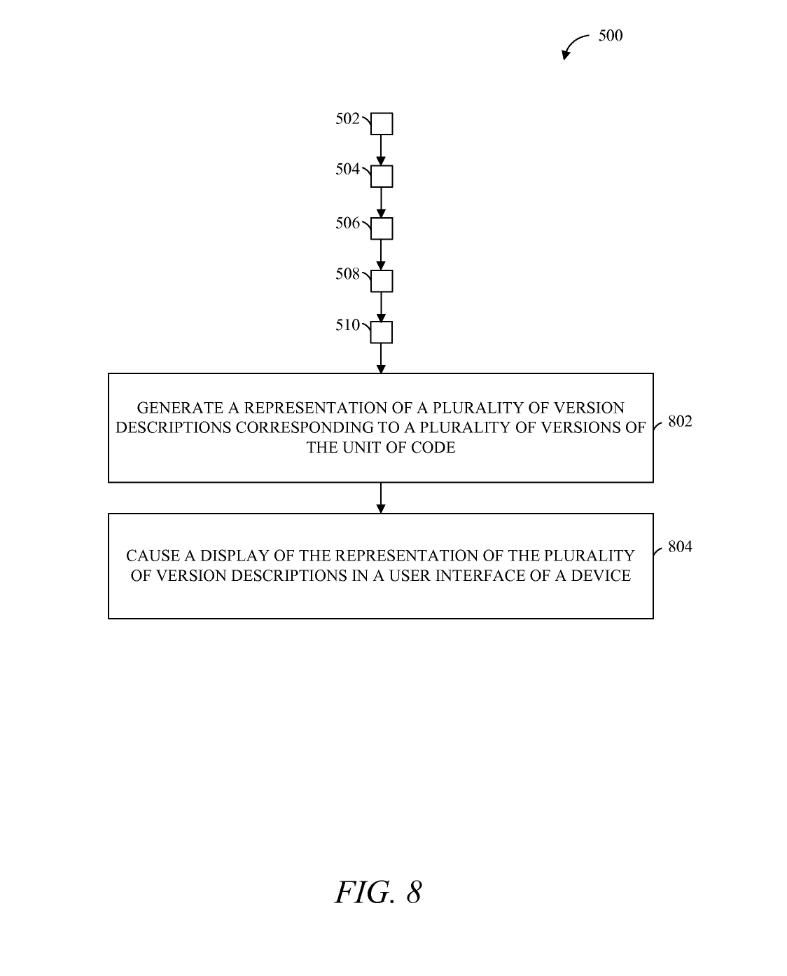

As shown in FIG. 8, the method 500 may include one or more of operations 802 and 804, according to some example embodiments. Method operation 802 is performed after method operation 510, in which the alert module 210 generates an alert based on the determining that the current KPI value is less than the previous KPI value.

At method operation 802, the presentation module 214 generates a representation of a plurality of version descriptions corresponding to a plurality of versions of the unit of code. The version descriptions may include a variety of information pertaining to a particular version (or commit) of the unit of code, such as a version identifier (ID) (or commit ID), an author ID (e.g., a name or email address of the author), a message that identifies a change performed to the unit of code in the particular version of the unit of code, and one or more KPIs.

Method operation 804 is performed after method operation 802. At method operation 804, the presentation module 214 causes a display of the representation of the plurality of version descriptions in a user interface of a device.

In some example embodiments, the representation comprises a graph including a plurality of nodes. One or more nodes of the plurality of nodes may include a version identifier that identifies a particular version of the plurality of versions of the unit of code and one or more KPI values generated based on the particular version of the plurality of versions of the unit of code.

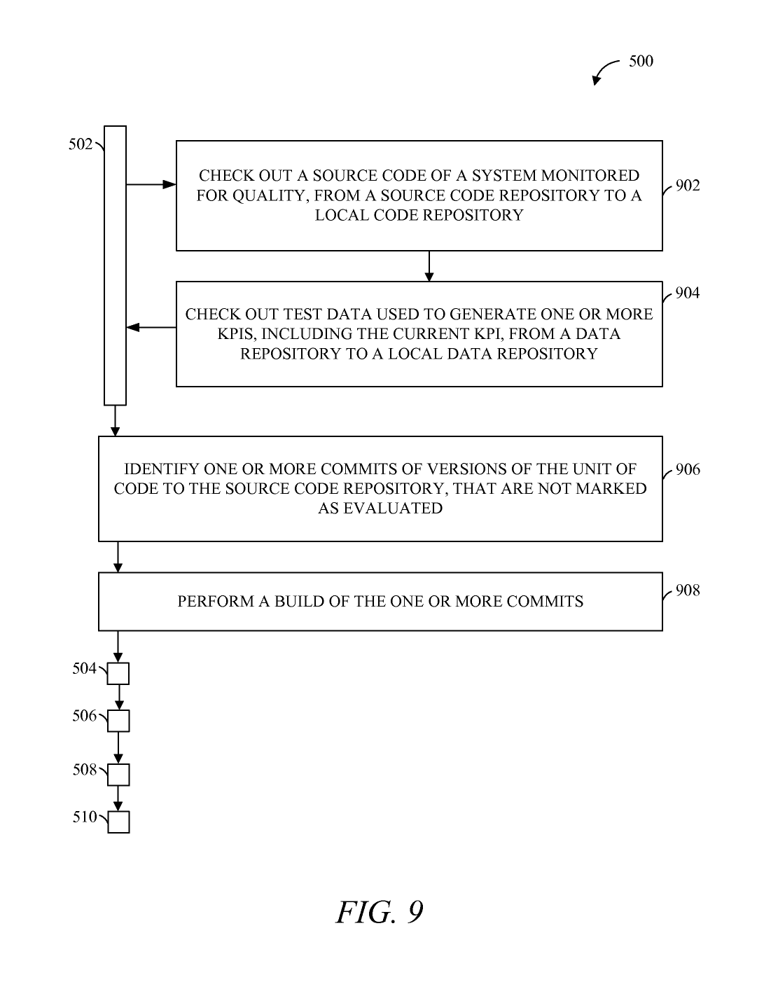

As shown in FIG. 9, the method 500 may include one or more of method operations 902, 904, 906, and 908, according to some example embodiments. Method operation 902 may be performed as part (e.g., a precursor task, a subroutine, or a portion) of method operation 502, in which the access module 202 accesses a current version of a unit of code that is not marked as evaluated, in a database. At method operation 902, the access module 202 checks out a source code of a system monitored for quality, from a source code repository to a local code repository.

Method operation 904 may be performed as part (e.g., a precursor task, a subroutine, or a portion) of method operation 502, after method operation 902. At method operation 904, the access module 202 checks out test data used to generate one or more KPIs, including the current KPI, from a data repository to a local data repository.

Method operation 906 may be performed after method operation 502. At method operation 906, the commit module 216 identifies one or more commits of versions of the unit of code to the source code repository, that are not marked as evaluated, in the database. The one or more versions of the unit of code may include the current version of the unit of code.

Method operation 908 may be performed after method operation 906. At method operation 908, the commit module 216 performs a build of the one or more commits.

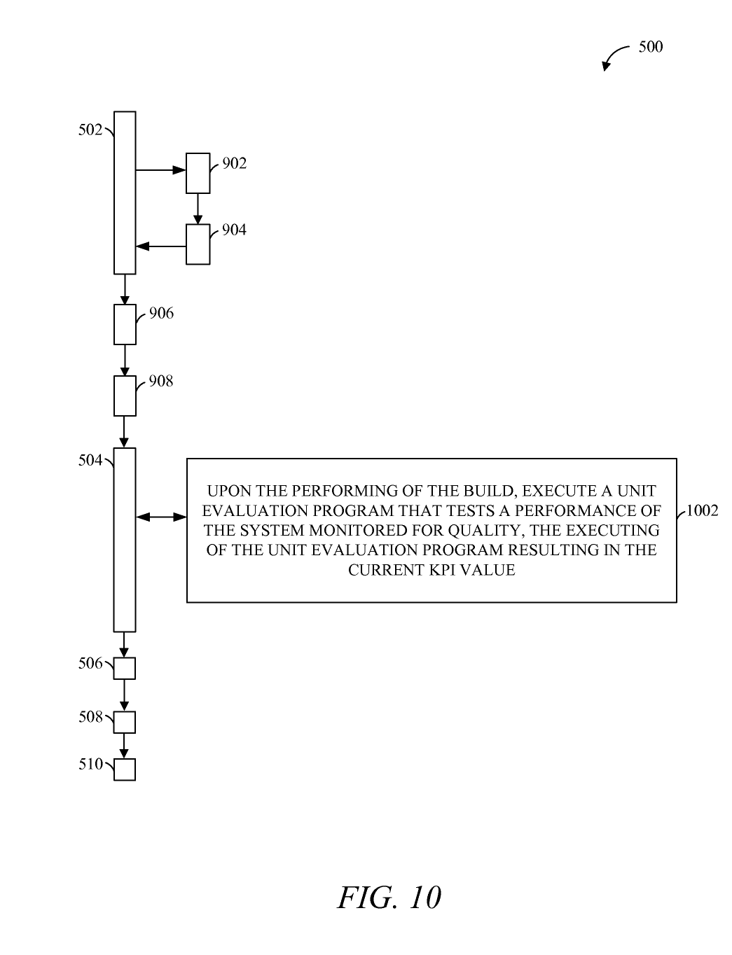

As shown in FIG. 10, the method 500 may include method operation 1002, according to some example embodiments. Method operation 1002 may be performed as part (e.g., a precursor task, a subroutine, or a portion) of method operation 504, in which the unit evaluation module 204 generates a current KPI value for the current version of the unit of code.

At method operation 1002, the unit evaluation module 204, upon the commit module 216 performing the build of the one or more commits, executes a unit evaluation program that tests a performance of the system monitored for quality. The executing of the unit evaluation program results in the current KPI value.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

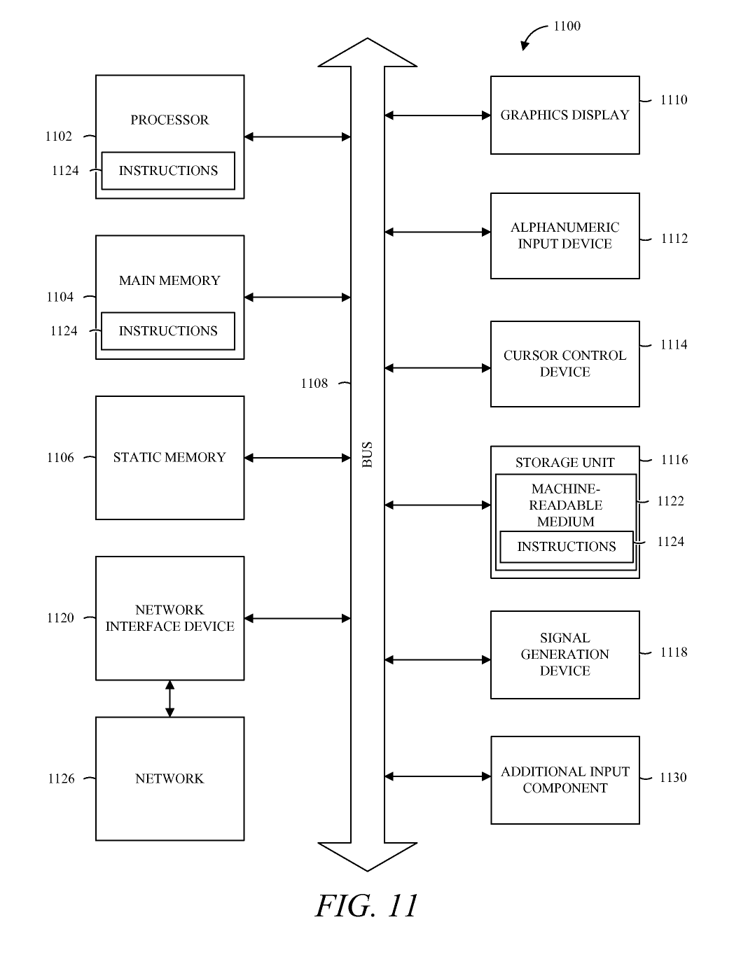

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage unit 1116, an audio generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 1126 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device, such as a smart phone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a current version of a unit of code that is not marked as evaluated, in a database;
generating a current key performance indicator (KPI) value for the current version of the unit of code based on an execution of the current version of the unit of code, the generating of the current KPI being performed by one or more hardware processors;
identifying a previous KPI value associated with a previous version of the unit of code that is marked as evaluated, in the database;
determining that the current KPI value is less than the previous KPI value; and
generating an alert based on the determining that the current KPI value is less than the previous KPI value, for presentation in a user interface of a device, the alert indicating a decreasing quality level associated with the current version of the unit of code.

2. The method of claim 1, wherein the generating of the KPI value for the current version of the unit of code is based on an output resulting from the execution of the current version of the unit of code.

3. The method of claim 1, wherein the current and previous KPI values are statistics metrics of a particular type.

4. The method of claim 3, wherein the current KPI value identifies a current precision value generated based on the output resulting from the execution of the current version of the unit of code and the previous KPI value identifies a previous precision value generated based on the output resulting from the execution of the previous version of the unit of code.

5. The method of claim 3, wherein the current KPI value identifies a current recall value generated based on the output resulting from the execution of the current version of the unit of code and the previous KPI value identifies a previous recall value generated based on the output resulting from the execution of the previous version of the unit of code.

6. The method of claim 3, wherein the current KPI value identifies a current F-measure value generated based on the output resulting from the execution of the current version of the unit of code and the previous KPI value identifies a previous F-measure value generated based on the output resulting from the execution of the previous version of the unit of code.

7. The method of claim 1, further comprising:
storing the current KPI value in a record of a database, in association with a reference to the current version of the unit of code; and
marking the current version of the unit of code as evaluated, in the database.

8. The method of claim 1, further comprising:
generating a representation of a plurality of KPI values corresponding to a plurality of versions of the unit of code, the plurality of KPI values including the current and previous KPI values; and
causing a display of the representation of the plurality of KPI values in a user interface of a device.

9. The method of claim 8, wherein the representation comprises a graph including a plurality of nodes, each node of the plurality of nodes representing a KPI value associated with a corresponding version of a plurality of versions of the unit of code.

10. The method of claim 1, further comprising:
generating a representation of a plurality of version descriptions corresponding to a plurality of versions of the unit of code; and
causing a display of the representation of the plurality of version descriptions in a user interface of a device.

11. The method of claim 10, wherein the representation comprises a graph including a plurality of nodes, one or more nodes of the plurality of nodes including a version identifier that identifies a particular version of the plurality of versions of the unit of code and one or more KPI values generated based on the particular version of the plurality of versions of the unit of code.

12. The method of claim 1, wherein the accessing of the current version of the unit of code that is not marked as evaluated includes:
checking out a source code of a system monitored for quality, from a source code repository to a local code repository, and
checking out test data used to generate one or more KPIs, including the current KPI, from a data repository to a local data repository; and
the method further comprising:
identifying one or more commits of versions of the unit of code to the source code repository, that are not marked as evaluated, in the database, the one or more versions of the unit of code including the current version of the unit of code; and
performing a build of the one or more commits.

13. The method of claim 12, wherein the generating of the current KPI value for the current version of the unit of code includes, upon the performing of the build, executing a unit evaluation program that tests a performance of the system monitored for quality, the executing of the unit evaluation program resulting in the current KPI value.

14. A system comprising:
a memory for storing instructions;
a hardware processor, which, when executing instructions, causes the system to:
access a current version of a unit of code that is not marked as evaluated, in a database;
generate a current key performance indicator (KPI) value for the current version of the unit of code based on an execution of the current version of the unit of code;
identify a previous KPI value associated with a previous version of the unit of code that is marked as evaluated, in the database;
determine that the current KPI value is less than the previous KPI value; and
generate an alert based on the determining that the current KPI value is less than the previous KPI value, for presentation in a user interface of a device, the alert indicating a decreasing quality level associated with the current version of the unit of code.

15. The system of claim 14, wherein the generating of the KPI value for the current version of the unit of code is based on an output resulting from the execution of the current version of the unit of code.

16. The system of claim 14, wherein the hardware processor further causes the system to:
generate a representation of a plurality of KPI values, including the current and previous KPI values, each of the plurality of the KPI values being associated with a particular version of the unit of code; and
cause a display of the representation of the plurality of KPIs in a user interface of a device.

17. The system of claim 14, wherein the hardware processor further causes the system to:
generate a representation of a plurality of versions of the unit of code and associated KPI values, including the current and previous KPI values; and
cause a display of the representation of the plurality of versions of the unit of code and associated KPI values in a user interface of a device.

18. The system of claim 14, wherein the accessing of the current version of the unit of code that is not marked as evaluated includes:
checking out a source code of a system monitored for quality, from a source code repository to a local code repository, and
checking out test data used to generate one or more KPIs, including the current KPI, from a data repository to a local data repository, and
wherein the hardware processor further causes the system to:
identify one or more commits of versions of the unit of code to the source code repository, that are not marked as evaluated, the one or more versions of the unit of code including the current version of the unit of code, and
perform a build of the one or more commits.

19. The system of claim 18, wherein the generating of the current KPI value for the current version of the unit of code includes, upon the performing of the build, executing a unit evaluation program that tests a performance of the system monitored for quality, the executing of the unit evaluation program resulting in the current KPI value.

20. A non-transitory machine-readable storage medium comprising instructions that, when executed by one or more processors of a machine, cause the machine to perform operations comprising:
accessing a current version of a unit of code that is not marked as evaluated, in a database;
generating a current key performance indicator (KPI) value for the current version of the unit of code based on an execution of the current version of the unit of code;
identifying a previous KPI value associated with a previous version of the unit of code that is marked as evaluated, in the database;
determining that the current KPI value is less than the previous KPI value; and
generating an alert based on the determining that the current KPI value is less than the previous KPI value, for presentation in a user interface of a device, the alert indicating a decreasing quality level associated with the current version of the unit of code.
